(19) United States
(12) Patent Application Publication
(10) Pub. No.: US 2011/0198553 A1
(43) Pub. Date: Aug. 18, 2011

(54) Wedge Post Base System

(76) Inventor: Steven W. Holterman, Franklin, WI (US)

(21) Appl. No.: 13/029,603

(22) Filed: Feb. 17, 2011

Related U.S. Application Data
(60) Provisional application No. 61/305,214, filed on Feb. 17, 2010.

(51) Int. Cl. E04H 17/20; F16M 11/24

(52) U.S. Cl. 256/65.14; 248/188.2

(57) ABSTRACT

A wedge post-base system for adjusting the orientation of an attached post relative to a mounting surface is disclosed. The base utilizes a two-piece structure, each piece having an angled mating surface relative to an opposing surface which allows a central axis of a post mounting collar to be altered, and thus the angle of the post itself. The resulting angle addresses the issue of mounting posts on a sloped plane. A fencing system having hinged railings and balusters as well as a railing system having a hinged upper rail are also disclosed.

### RELATED APPLICATION

The present application claims priority to U.S. Provisional Application No. 61/305,214 filed Feb. 17, 2010, and titled “Wedge Post Base System,” and incorporates the same herein by reference.

### TECHNICAL FIELD OF THE INVENTION

The present device relates to a base system for posts, including posts for fencing, railings, signs, lights, poles, and other such structures. Particularly, the present device relates to a base system effective for adjusting the post angle.

### BACKGROUND OF THE INVENTION

The post is, generally speaking, a basic component of support for many everyday structures. Fences, signs, stair railings, lights, supports, tents, cages, barriers, and a number of other such structures all use posts as an integral support element. For some, erection of such structures can occur on a perfectly flat, smooth surface. For others, however, sloping and uneven terrain may present the most difficult challenge for erecting a structure which requires parallel posts along an entire construction.

The present invention overcomes these and many other disadvantages of previous devices. Disclosed is a fencing system and a fence post base which can be decorative, yet functional; versatile in use for supporting any number of structures, and particularly fencing; and it is easy to install wherever it is needed.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of a section of the present fencing system on a substantially flat surface;

FIG. 2 is a perspective view of the section of fencing of FIG. 1 mounted on a pitched surface;

FIGS. 3-8 are various views of an embodiment of components of a two-piece mounting plate assembly arranged for a level surface mounting (FIG. 3) and for a pitched surface mounting (FIG. 4);

FIGS. 9-12 are various views of an embodiment of fencing post and railing attachments arranged to accommodate level and pitched mounting;

FIGS. 13-16 are various views of an embodiment of fencing railing and baluster attachments arranged to accommodate level and pitched mounting;

FIGS. 17-20 are various views of an embodiment of a rubber boot assembly used to cover a mounting plate assembly of the present invention, showing both a level surface mounting (FIG. 17) and a pitched surface mounting (FIG. 18);

FIGS. 21(a) and (b) are views of an embodiment of a base leveling plate used with the rubber boot assembly illustrated in FIGS. 17-20;

FIGS. 22(a) and (b) are views of an embodiment of a top leveling plate used with the base plate of FIG. 21; and

FIGS. 23(a) and (b) are views of an embodiment of a top plate used with the base leveling plate and top leveling plate of FIGS. 21 and 22, respectively.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

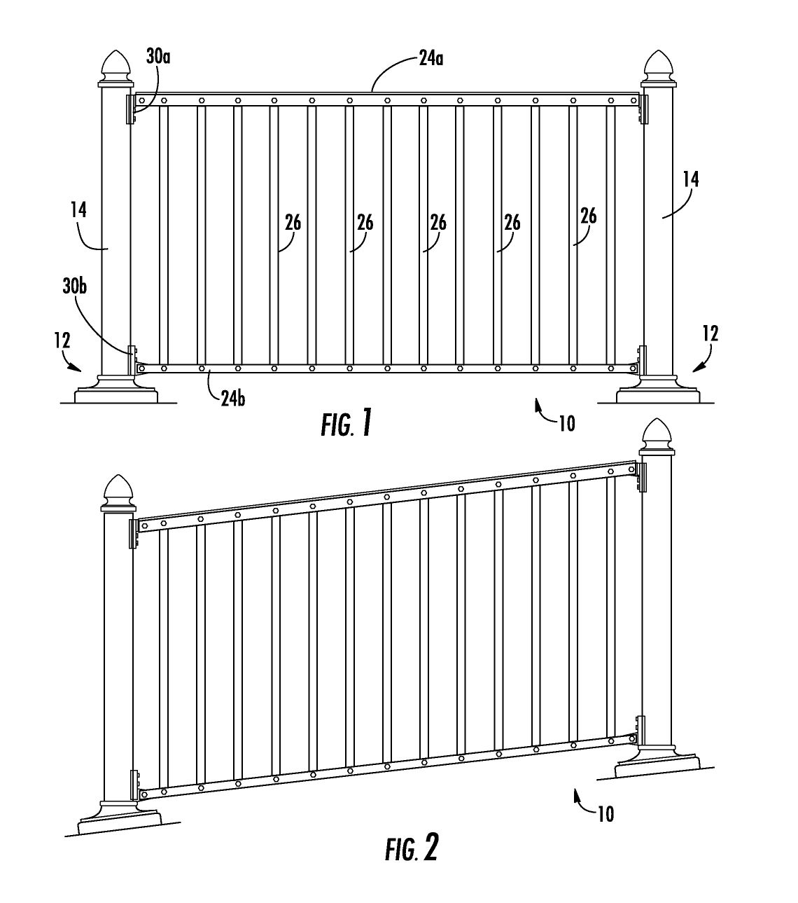

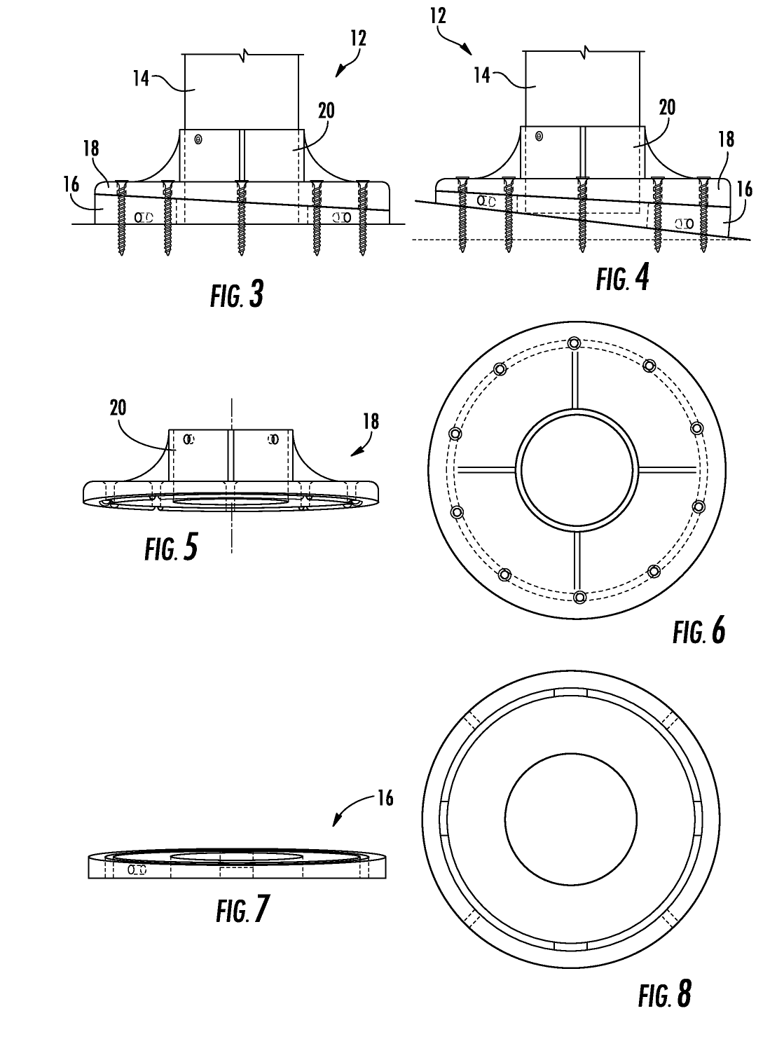

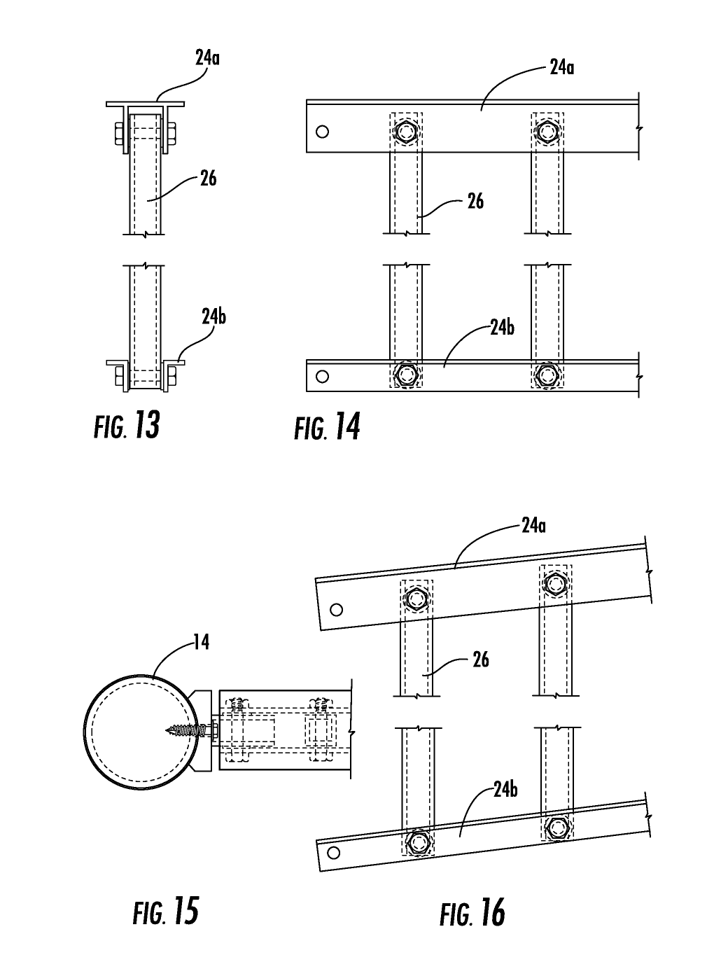

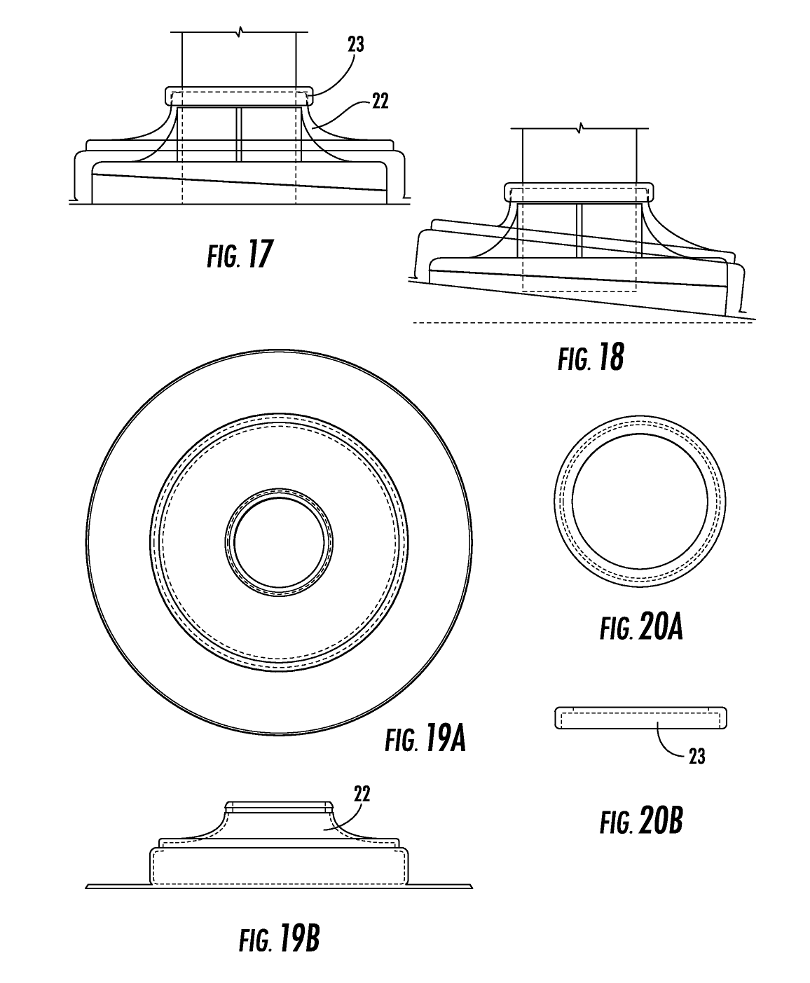

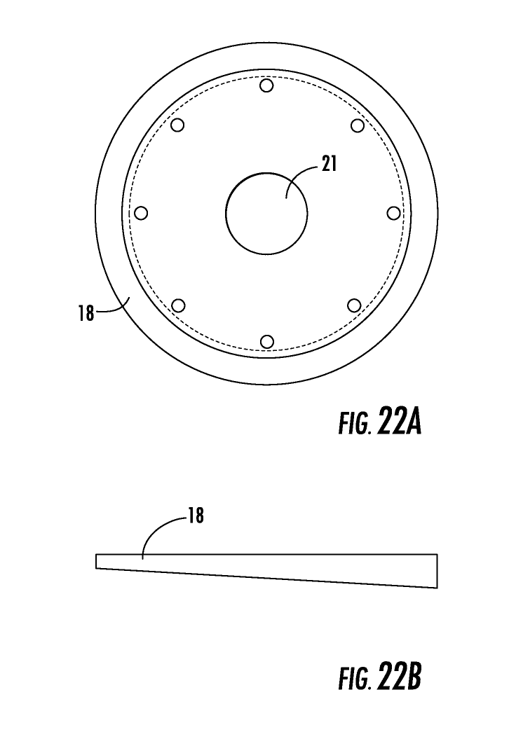

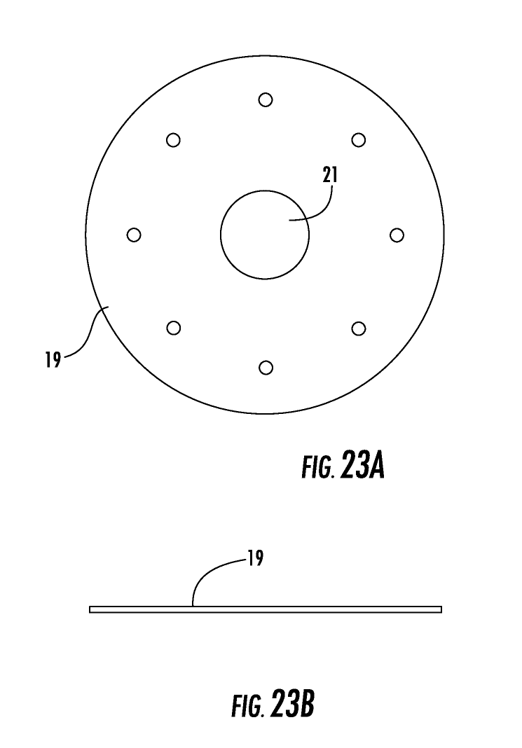

Referring to FIGS. 1-23, there are illustrated embodiments of a fencing (or railing) system and a post mounting system generally designated by the numerals 10 and 12, respectively. The post mounting system 12 is illustrated in connection with the fencing (or railing) system 10, but it should be understood that the post mounting system is to be more broadly enabled by the present disclosure. That is, the post mounting system 12 may be used for the mounting of posts and similar post-like structures used in the erection of, but not limited to, fencing, railings, signage, lighting, displays, shelving, temporary building structures, blockades, supports, markers, scaffolding, artificial foliage, and other such structures. Those skilled in the art would understand the application of the following fencing related disclosure to each of these other fields without undue experimentation.

Referring to FIGS. 1 and 2, an embodiment of the fencing system 10 is illustrated as it might appear mounted to a level surface (FIG. 1) and to a pitched surface (FIG. 2). The fencing system 10 comprises at least one post structure and a plurality of fencing structures. Each post structure comprises a post 14 and a posting mounting system 12 for supporting fencing. The fencing is comprised of an upper rail 24a attached by an end to the post 14 via a bracket 30a, a lower rail 24b attached by an end to the post 14 via a bracket 30b, and a plurality of balusters 26, each connected by opposing ends to the upper rail 24a and the lower rail 24b.

In the embodiment illustrated in FIGS. 4-8, the post mounting system 12 comprises a lower mounting plate 16 having a bottom surface and a mating surface, an upper mounting plate 18 having a top surface and a mating surface for engaging the mating surface of the lower plate 16, and a post collar 20 attached to the top surface of the upper plate 18 and having a central axis (X), the post collar 20 being coupled to a post 14 to retain the post 14 in a desired, typically vertical position. The mating surface of the lower plate 16 and the mating surface of the upper plate 18 are each angled relative to the bottom surface and top surface, respectively, such that the lower plate 16 and the upper plate 18 can be rotated with respect to one another to alter an angle of the central axis (X) relative to the bottom surface of the lower plate 16.

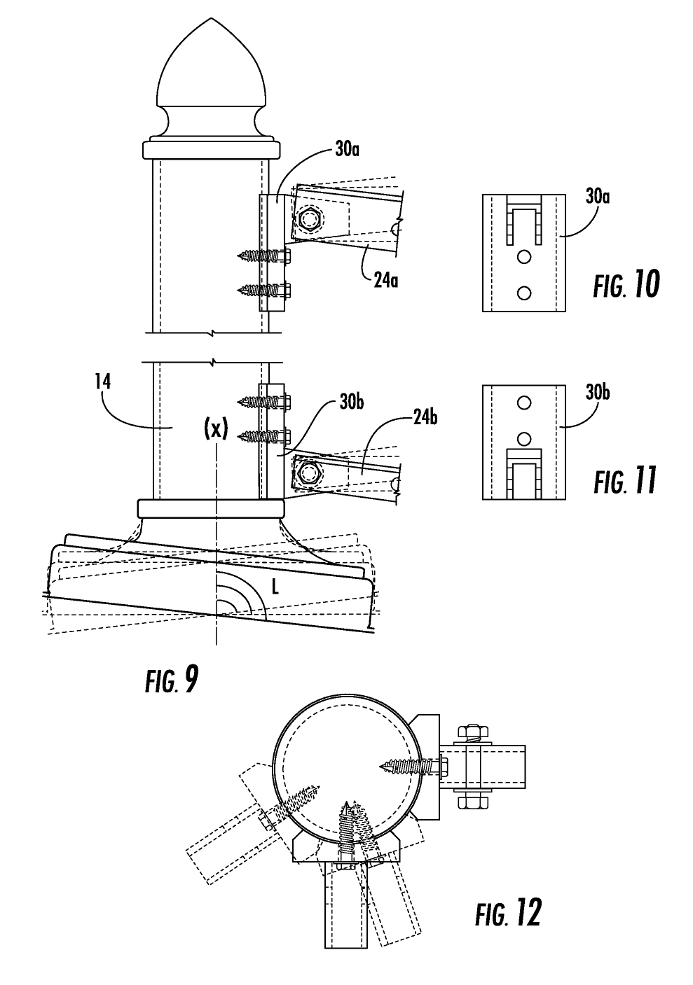

Referring to FIGS. 9-16, in a preferred embodiment of the system 10, fencing structures are attached to at least one post 14 and comprises an upper rail 24a attached by an end to the post 14 via a bracket 30a, a lower rail 24b attached by an end to the post 14 via a bracket 30b, and a plurality of balusters 26, each connected by opposing ends to the upper rail and the lower rail. The attachment of rails 24a, 24b to a post 14 is preferably hinged via brackets 30a, 30b to allow inclination of the fencing structures to parallel or nearly parallel the sloping surface onto which the fencing system 10 is mounted. Each hinged attachment of a rail 24a, 24b to a post 14 as well as the hinged attachment of the balusters 26 to a rail 24a, 24b (see FIG. 16) preferably allows a range of movement from normal of about ±10 degrees. Most preferably, the range of movement of the rails 24a, 24b and balusters 26 of the fencing system 10 will be approximately equal to the angle of inclination for the post 14 relative to the mounting surface.

Where a railing system is desired (not shown), the lower rail 24b and the balusters 26 can be omitted. The railing system can be placed along a stairway, on a hill, along a trail (paved or unpaved), and other such terrain where a hand-railing is useful.

For a complete decorative look, the fencing system may further include a boot 22, preferably made of a weather-resistant rubber material, for covering a non-decorative embodiment of the assembled mounting plates, as illustrated in FIGS. 17-23. The rubber boot 22 would protect the base hardware against the elements in an outdoor mounting. However, where such conditions are not an issue, such as indoors, the boot 22 may be comprised of a plastic, metal or alloy with an aesthetically-pleasing surface, for example.

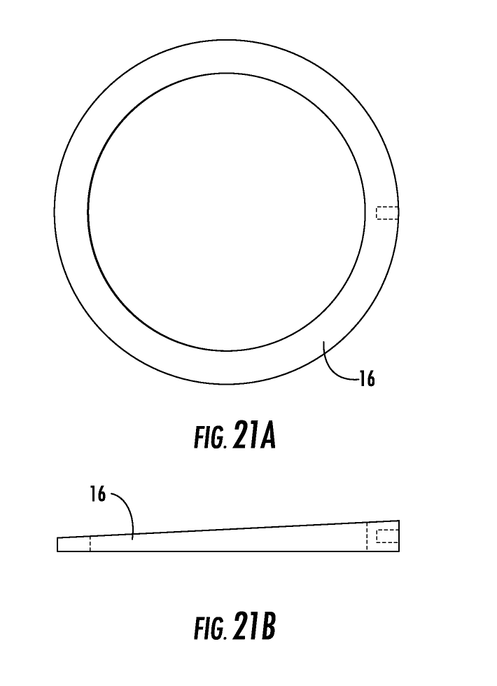

Another embodiment of the leveling post mounting system 12 is illustrated in the drawings of FIGS. 21-23. The base or lower plate 16 has a bottom surface and a mating surface, while an upper mounting plate 18 includes a top surface and a mating surface for engaging the mating surface of the lower plate 16. A top plate 19 attaches to the top surface of the upper mounting plate 18. The three-piece assembly has a central opening 21 for retaining a post 14 in a desired, typically vertical position. The mating surface of the lower plate 16 and the mating surface of the upper plate 18 are each angled relative to the bottom surface and top surface, respectively, such that the lower plate 16 and the upper plate 18 can be rotated with respect to one another to alter an angle of a central axis relative to the bottom surface of the lower plate 16, as described in the previous embodiment of FIGS. 3-8.

Once secured with a post, the assembly of FIGS. 21-23 can be provided with the boot assembly of FIGS. 17-20. The cap 23 is used at the upper end of the boot 22 to secure to the associated post 14. The cap 23 is also preferably made from a material similar to that of the boot—e.g., rubber, metal, plastic. In the case of a rubber boot, the flexible material allows it to accommodate multiple different degrees of sloping surfaces while still maintaining an effective covering of the post base.

As previously described for the embodiment of FIGS. 3-8 and 21-23, the wedge post base system 12 comprises a lower plate 16 having a bottom surface and a mating surface, an upper plate 18 having a top surface and a mating surface for engaging the mating surface of the lower plate 16, and a post collar 20 having a central axis (X) and attached to the top surface of the upper plate 18. The mating surface of the lower plate 16 and the mating surface of the upper plate 18 are angled relative to the bottom surface and top surface, respectively. That is, the angles of each of these surfaces are preferably identical such that when arranged in an assembled configuration, as shown in FIGS. 3 and 4, the angles can cancel each other (FIG. 3) or they can add to a greater angle (FIG. 4). By rotating the lower and upper plates, 16 and 18, with respect to one another the angle of the central axis relative to the bottom surface of the lower plate 16 can be changed.

The angle of the central axis relative to the bottom surface is preferably adjustable by rotation of the two surfaces relative to one another within the range of from about 90 degrees (normal) to about 75 degrees (±15 degrees). Alternatively, the angle of the central axis to the bottom surface is adjustable between one of either (i.e., from one to the other and back again) about 90 degrees (normal) and about 84 degrees (±6 degrees). A total inclination of 6.4 degrees is illustrated in FIG. 4 as a result of two 3.2 degree angles for the mating surfaces on the upper plate 16 and the lower mounting plate 18. Preferably, the angle of the mating surfaces of the upper and lower plates are within the range of from about 1 degree to about 10 degrees to accommodate most inclined surfaces.

Finally, the upper and lower plates could be arranged to secure an existing hollow post. For example, instead of the post collar 20, a post stump (not shown) having a central axis (X) could be attached to the top surface of the upper plate 18. Then, a hollow or partially hollow post could be mounted and secured to the post stump. This would allow for the mounting of many existing post, such as those used for street lighting, on slanted or sloping surfaces.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A post base system comprising:
a lower plate having a bottom surface and a mating surface;
an upper plate having a top surface and a mating surface for engaging the mating surface of the lower plate; and
a post collar having a central axis and attached to the top surface of the upper plate;
wherein the mating surface of the lower plate and the mating surface of the upper plate are angled relative to the bottom surface and top surface, respectively, and the lower and upper plates can be rotated with respect to one another to alter an angle of the central axis relative to the bottom surface of the lower plate.

2. The post base system of claim 1, further comprising a flexible boot for covering the assembled plates.

3. The post base system of claim 1, wherein the angle of the central axis relative to the bottom surface is adjustable within the range of from about 90 degrees (normal) to about 75 degrees (±15 degrees).

4. The post base system of claim 3, wherein the angle of the central axis to the bottom surface is adjustable between one of either about 90 degrees (normal) and about 84 degrees (±6 degrees).

5. The post base system of claim 1, wherein the angle of the mating surfaces of the upper and lower plates are within the range of from about 1 degree to about 10 degrees.

6. The post base system of claim 1, wherein the system is for posts used in one of the following: fencing, signs, lighting, displays, temporary building structures, blockades, rails, supports, markers, scaffolding, and other such structures.

7. A fencing system comprising:
a plurality of post structures, each structure comprising:
a post for supporting fencing;
a lower mounting plate having a bottom surface and a mating surface;
an upper mounting plate having a top surface and a mating surface for engaging the mating surface of the lower plate; and
a post collar attached to the top surface of the upper plate and having a central axis, the post collar being coupled to the post to retain the post in a desired position;
wherein the mating surface of the lower plate and the mating surface of the upper plate are angled relative to the bottom surface and top surface, respectively, and the lower and upper plates can be rotated with respect to one another to alter an angle of the central axis relative to the bottom surface of the lower plate; and
a plurality of fencing structures, each structure attached to at least one post and comprising:
an upper rail attached by an end to the post;
a lower rail attached by an end to the post; and
a plurality of balusters, each connected by opposing ends to the upper rail and the lower rail;
wherein the attachment of the rails and the balusters are hinged.

8. The fencing system of claim 7, further comprising a flexible boot for covering the assembled plates.

9. The fencing system of claim 7, wherein each hinged attachment of a rail to a post and a baluster to a rail allows a range of movement from normal of about ±10 degrees.

10. A post base system comprising:
a lower plate having a bottom surface and a mating surface; and
an upper plate having a top surface and a mating surface for engaging the mating surface of the lower plate;
wherein the mating surface of the lower plate and the mating surface of the upper plate are angled relative to the bottom surface and top surface, respectively, and the lower and upper plates can be rotated with respect to one another to alter an angle of the central axis relative to the bottom surface of the lower plate.

11. The post base system of claim 10, further comprising a top plate mounted to the top surface of the upper plate.

12. The post base system of claim 10, further comprising a flexible boot for covering the assembled plates.

13. The post base system of claim 12, wherein the angle of the central axis relative to the bottom surface is adjustable within the range of from about 90 degrees (normal) to about 75 degrees (±15 degrees).

14. The post base system of claim 13, wherein the angle of the central axis to the bottom surface is adjustable between one of either about 90 degrees (normal) and about 84 degrees (±6 degrees).

15. The post base system of claim 12, wherein the angle of the mating surfaces of the upper and lower plates are within the range of from about 1 degree to about 10 degrees.

16. A railing system comprising:
a plurality of post structures, each structure comprising:
a post for supporting fencing;
a lower mounting plate having a bottom surface and a mating surface;
an upper mounting plate having a top surface and a mating surface for engaging the mating surface of the lower plate; and
a post collar attached to the top surface of the upper plate and having a central axis, the post collar being coupled to the post to retain the post in a desired position;
wherein the mating surface of the lower plate and the mating surface of the upper plate are angled relative to the bottom surface and top surface, respectively, and the lower and upper plates can be rotated with respect to one another to alter an angle of the central axis relative to the bottom surface of the lower plate; and
an upper rail attached by an end to a post structure.

17. The railing system of claim 16, wherein the attachment of the upper rail is hinged.
